(19) United States
(12) Patent Application Publication
(10) Pub. No.: US 2025/0085156 A1
(43) Pub. Date: Mar. 13, 2025

(54) LOADING GRANULATED METALLIC UNITS INTO RAILCARS, AND ASSOCIATED SYSTEMS, DEVICES, AND METHODS

(71) Applicant: SUNCOKE TECHNOLOGY AND DEVELOPMENT LLC, Lisle, IL (US)

(72) Inventors: John Francis QUANCI, Haddonfield, NJ (US); John Michael RICHARDSON, Devon, PA (US); Patrick James MULLARKEY, Manhattan, IL (US); David James SCHWAKE, Aurora, IL (US); Andrew Michael BUTOR, Cranberry Township, PA (US); Jonathan Hale PERKINS, Lisle, IL (US); Chun Wai CHOI, Lisle, IL (US)

(21) Appl. No.: 18/882,045

(22) Filed: Sep. 11, 2024

Related U.S. Application Data
(60) Provisional application No. 63/581,946, filed on Sep. 11, 2023.

(51) Int. Cl. G01G 13/00; B61D 7/00; B61K 13/00

(52) U.S. Cl. CPC G01G 13/006; B61K 13/00; B61D 7/00

(57) ABSTRACT

Loading granulated metallic units (GMUs) into railcars, and associated systems, devices, and methods, are disclosed here. In some embodiments, an apparatus for loading GMUs into a railcar comprises a housing unit, a weigh bin, a weigh bin gate, a hopper, and an articulating chute. GMUs in the weigh bin are discharged via gravity through the weigh bin gate when the weigh bin gate opens. The hopper is configured to guide GMUs received from the weigh bin to the articulating chute. The articulating chute is angled and rotatable about an axis of the hopper such that, when rotated, the end of the chute is closer to the floor of a railcar. In some embodiments, the chute includes telescoping segments.

### CROSS-REFERENCE TO RELATED APPLICATIONS

The present application claims the benefit of U.S. Provisional Patent Application No. 63/581,946, filed Sep. 11, 2023, and titled “SYSTEM AND METHOD FOR CONTINUOUS GRANULATED PIG IRON (GPI) PRODUCTION,” the disclosure of which is incorporated herein by reference in its entirety. The present application is related to the following applications, the disclosures of which are incorporated herein by reference in their entireties: U.S. patent application Ser. No. 18/882,116 [Attorney Docket No. 084553.8072.US00], filed Sep. 11, 2024, and titled “RAILCARS FOR TRANSPORTING GRANULATED METALLIC UNITS, AND ASSOCIATED SYSTEMS, DEVICES, AND METHODS”; U.S. patent application Ser. No. 18/882,191 [Attorney Docket No. 084553.8074.US00], filed Sep. 11, 2024, and titled “LOW-SULFUR GRANULATED METALLIC UNITS, AND ASSOCIATED SYSTEMS, DEVICES, AND METHODS”; U.S. patent application Ser. No. 18/882,638 [Attorney Docket No. 084553.8075.US00], filed Sep. 11, 2024, and titled “CONTINUOUS GRANULATED METALLIC UNITS PRODUCTION, AND ASSOCIATED SYSTEMS, DEVICES, AND METHODS”; U.S. patent application Ser. No. 18/882,661 [Attorney Docket No. 084553.8076.US00], filed Sep. 11, 2024, and titled “USE OF A BASIC OXYGEN FURNACE TO PRODUCE GRANULATED METALLIC UNITS, AND ASSOCIATED SYSTEMS, DEVICES, AND METHODS”; U.S. patent application Ser. No. 18/882,256 [Attorney Docket No. 084553.8077.US00], filed Sep. 11, 2024, and titled “LOW-CARBON GRANULATED METALLIC UNITS, AND ASSOCIATED SYSTEMS, DEVICES, AND METHODS”; U.S. patent application Ser. No. 18/882,531 [Attorney Docket No. 084553.8078.US00], filed Sep. 11, 2024, and titled “TORPEDO CARS FOR USE WITH GRANULATED METALLIC UNIT PRODUCTION, AND ASSOCIATED SYSTEMS, DEVICES, AND METHODS”; U.S. patent application Ser. No. 18/882,384 [Attorney Docket No. 084553.8079.US00], filed Sep. 11, 2024, and titled “TREATING COOLING WATER IN IRON PRODUCTION FACILITIES, AND ASSOCIATED SYSTEMS, DEVICES, AND METHODS”; U.S. patent application Ser. No. 18/882,465 [Attorney Docket No. 084553.8080.US00], filed Sep. 11, 2024, and titled “USE OF RESIDUAL IRON WITHIN GRANULATED METALLIC UNIT PRODUCTION FACILITIES, AND ASSOCIATED SYSTEMS, DEVICES, AND METHODS”; U.S. patent application Ser. No. 18/882,501 [Attorney Docket No. 084553.8081.US00], filed Sep. 11, 2024, and titled “PROCESSING GRANULATED METALLIC UNITS WITHIN ELECTRIC ARC FURNACES, AND ASSOCIATED SYSTEMS AND METHODS”.

### TECHNICAL FIELD

This present technology relates to systems, devices, and methods of loading granulated metallic units into railcars.

### BACKGROUND

Granulated pig iron (GPI) is a form of pig iron that is granulated into small, uniform particles, making it easier to handle, transport, and use in different metallurgical processes compared to conventional pig iron. The demand for GPI has been steadily increasing due to its versatile applications in various industries, including automotive, construction, and manufacturing. The growing popularity of GPI can be attributed to its high purity, consistent quality, and the efficiency it brings to the production of steel and other iron-based products.

Granulated pig iron is produced by rapidly cooling molten pig iron with water, resulting in the formation of granules. This process, known as granulation, is typically carried out after processing in blast furnaces. However, current production methods are often characterized by intermittent production cycles due to various operational constraints, such as the need for periodic maintenance, fluctuations in raw material supply, and energy consumption issues. These interruptions not only affect the overall efficiency but also lead to increased production costs and variability in product quality. Therefore, there is a need for an improved production process that can ensure continuous and stable granulation of pig iron, thereby enhancing productivity and reducing operational costs.

### BRIEF DESCRIPTION OF THE DRAWINGS

Features, aspects, and advantages of the presently disclosed technology may be better understood with regard to the following drawings.

FIG. 1 is a schematic block diagram of a continuous granulated metallic unit (GMU) production system configured in accordance with embodiments of the present technology.

FIG. 2 is a plan view of the continuous GMU production system of FIG. 1, configured in accordance with embodiments of the present technology.

FIG. 3 is an enlarged view of the continuous GMU production system of FIG. 2.

FIG. 4 is a schematic illustration of a system for loading GMUs into one or more railcars, configured in accordance with embodiments of the present technology.

FIG. 5 is partially schematic illustration of a system for loading GMUs into one or more railcars, configured in accordance with embodiments of the present technology.

FIG. 6 is a partially schematic side view of an articulating apparatus, configured in accordance with embodiments of the present technology.

FIG. 7 is a partially schematic side view of an articulating apparatus, configured in accordance with additional embodiments of the present technology.

FIG. 8A is a partially schematic side view of a telescoping apparatus in a retracted configuration, configured in accordance with embodiments of the present technology.

FIG. 8B is a partially schematic side view of the telescoping apparatus of FIG. 8A in an extended configuration, configured in accordance with embodiments of the present technology.

FIG. 9 is a partially schematic side view of a telescoping articulating apparatus, configured in accordance with embodiments of the present technology.

FIG. 10 is a flow diagram of a method of loading GMUs into railcars via an articulating apparatus, configured in accordance with embodiments of the present technology.

FIG. 11 is a flow diagram of a method of loading GMUs into railcars via a telescoping apparatus, configured in accordance with embodiments of the present technology.

FIG. 12 is a flow diagram of a method of loading GMUs into railcars via an apparatus that articulates and telescopes, configured in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

The present technology is generally directed to loading granulated metallic units (GMUs) into railcars, and associated systems, devices, and methods. The GMUs (i.e., a plurality of particles) can be a low-carbon granulated iron (GI) and/or GPI. Conventional technology for loading various industrial products (e.g., GPI) into railcars typically involves discharging the product from a significant height into the container compartment of a railcar. Due to the relatively high-density and heavy granulated industrial products and substantial drop of these products, such loading forcefully impacts the interior surfaces of the railcar and can lead to rapid wear and erosion of the interior surfaces of the railcar. This not only compromises the railcar's structural integrity, but also increases maintenance costs and downtime, thereby impacting operational efficiency and profitability, as well as lifespan of the railcar. These effects compound over time, which can be particularly problematic for railcars expected to be in service for many years.

Embodiments of the present technology address at least some of these issues by providing, among other things, an articulating chute configured to reduce the force with which GMUs impacts the railcar. For example, in some embodiments, the articulating chute is configured to rotate about an axis of a hopper positioned above the chute such that rotation positions the end/exit of the chute closer to the floor of the railcar. This reduces the height the GMUs begin free fall from the chute into the railcar, which reduces the time the GMUs spends in free fall, ultimately reducing the speed and force with which the GMUs impinge on the railcar. In some embodiments, the articulating chute is angled relative to the direction of gravity and/or based on an angle of repose of the GMUs. The angle of the articulating chute reduces the fall speed of the GMUs through the chute, ultimately reducing the speed and force of impact on the railcar. In some embodiments, the articulating chute includes one or more telescoping functionality and/or segments, which, when extended, position the end/exit of the chute closer to the floor of the railcar, which reduces the speed and force of GMU impact. In some embodiments, the articulating chute includes one or more baffle elements internal to the chute, which disrupt the fall of GMUs through the chute and ultimately reduces the force and speed of impact.

For example, in some embodiments, the present technology discloses an apparatus for loading GMUs into a railcar that comprises a housing unit, a weigh bin and weigh bin gate, a hopper positioned to receive GMUs from the weigh bin via the weigh bin gate, and an articulating chute coupled to the hopper and positioned to receive GMUs from the hopper. The housing unit defines the structure of the apparatus by housing the weigh bin, weigh bin gate, hopper, and articulating chute. The weigh bin is configured to weigh and/or determine a desired quantity of GMUs. The GMUs in the weigh bin can be discharged via gravity through the weigh bin gate when the weigh bin gate moves from a closed position to an open position. The hopper includes an inlet of a first diameter which receives the GMUs discharged from the weigh bin, and an outlet of a second diameter less than the first diameter, which is configured to guide GMUs received at the inlet to the articulating chute. The articulating chute is angled (e.g., based on an angle of repose of the GMUs) and coupled to the hopper. The chute is further rotatable about an axis of the hopper such that, when rotated from a first position to a second position, the end of the chute is closer to the floor of the railcar.

The GMU production system is designed for continuous operation. Relative to non-continuous GPI production systems, embodiments of the present technology enhance energy efficiency and reduces emissions by minimizing the need for frequent shutdowns and restarts, which are often associated with excessive venting and/or less efficient operations. As described herein, some embodiments include (i) a desulfurization unit that lowers the sulfur content in molten metal, thereby reducing sulfur dioxide (SO₂) emissions, (ii) dust collection units that filter out particulate matter, thereby reducing air pollution, (iii) infrastructure to recycle fines, slag, iron skulls and other residual iron/previously-processed iron, thereby reducing the environmental impact associated with raw material extraction and conserving natural resources, and/or (iv) water management and cooling systems that minimize heat losses, enhance thermal efficiency of production processes, and optimize water consumption. Overall, the continuous GMU production system enhances productivity while minimizing greenhouse gas emissions and waste, contributing to more sustainable industrial practices and helping mitigate climate change.

Relatedly, conventional iron production has a significant environmental impact due to its high energy consumption and emissions of pollutants. As such, embodiments of the present technology which relate to GMU production systems can reduce this impact. Sulfur, phosphorus, and silicon in GPI negatively affect the quality and properties of final metal products, leading to issues like reduced ductility, toughness, and weldability, as well as surface defects and brittleness. These impurities also contribute to the formation of non-metallic inclusions and excessive slag, complicating metal processing and compromising product quality. Sulfur, in particular, accelerates the wear and erosion of metal processing equipment, increasing maintenance costs and decreasing equipment lifespan. Embodiments of the present technology include methods for removing these impurities in part can improve the quality and durability of final metal products and enhances the efficiency and lifespan of processing equipment, leading to cost savings and more sustainable production practices.

In the FIGS., identical reference numbers identify generally similar, and/or identical, elements. Many of the details, dimensions, and other features shown in the FIGS. are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Embodiments of a Continuous Granulated Metallic Unit Production System

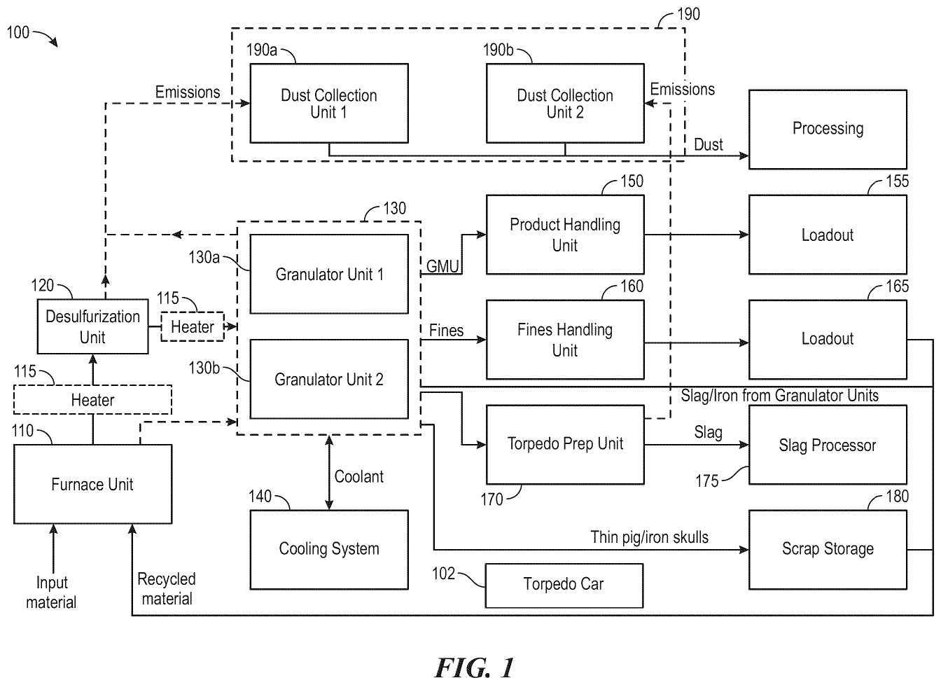

FIG. 1 is a schematic block diagram of a continuous GMU production system 100 (“the system 100”) configured in accordance with embodiments of the present technology. As explained elsewhere herein, GMUs can include granulated iron (GI), granulated pig iron (GPI), granulated steel (GS), or GMU. Relatedly, molten metal can include molten pig iron or molten steel. As used herein, the term “continuous” should be interpreted to mean continuous operations cycles, including in batch or semi-batch operations, for at least 4 hours, 6 hours, 8 hours, 10 hours, 12 hours, 16 hours, 20 hours, or 24 hours. The system 100 can include a furnace unit 110, a desulfurization unit 120, granulator units 130 including a first granulator unit 130a and a second granulator unit 130b, and a cooling system 140. The furnace unit 110 can receive input materials (e.g., iron ore, coke, limestone, and/or preheated air) and/or recycled material, which can be sourced from downstream components of the system 100 as described in further detail herein. Equations (1)-(6) below detail some of the chemical processes controlled at the furnace unit.

C+O₂→CO₂ (1)

CO₂+C→2CO (2)

Fe₂O₃+3CO→2Fe+3CO₂ (3)

Fe₂O₃+3C→2Fe+3CO (4)

CaCO₃→CaO+CO₂ (5)

CaO+SiO₂→CaSiO₃ (6)

Equation (1) represents the combustion of coke, which is a form of carbon. When coke reacts with oxygen gas introduced into the furnace (e.g., via an oxygen lance), it forms carbon dioxide. This exothermic reaction releases a significant amount of heat, which is essential for maintaining the high temperatures required for subsequent reactions. The carbon dioxide produced via Equation (1) further reacts with additional coke to form carbon monoxide, as illustrated by Equation (2). This endothermic reaction helps to moderate the temperature within the furnace unit 110. Equations (3) and (4) represent the reduction of iron ore (Fe₂O₃). As illustrated by Equation (3), the iron oxide reacts with the carbon monoxide produced via Equation (2), which acts as a reducing agent to convert iron ore into iron and produces carbon dioxide as a byproduct. Alternatively, as illustrated by Equation (4), the iron ore may be reduced directly by the coke, albeit less commonly. Equations (5) and (6) represent the formation of slag. As illustrated by Equation (5), the calcium carbonate/limestone (CaCO₃) can decompose into calcium oxide and carbon dioxide at the high temperatures of the furnace unit 110. As illustrated by Equation (6), the calcium oxide can then react with silica (SiO₂), an impurity in the iron ore, to form calcium silicate (CaSiO₃), also known as slag. The furnace unit 110 can output molten iron (from Equations (3) and (4)) and slag (from Equations (5) and (6)).

In some embodiments, the input materials (e.g., the coke, the iron ore, and/or the limestone) include sulfur, which can remain in the molten iron output by the furnace unit 110. A torpedo car 102 or other transfer vessel can transfer the molten iron from the furnace unit 110 to the desulfurization unit 120. The desulfurization unit 120 can include equipment to reduce the sulfur content of the molten iron. For example, one or more lances can be used to deliver magnesium (Mg), calcium carbide (CaC₂), or other sulfur-reducing agent to the molten iron. In some embodiments, the molten iron is desulfurized while remaining inside the torpedo car 102. Equations (7) and (8) below detail the reactions between the sulfur and the sulfur-reducing agents.

Mg+S→MgS (7)

CaC₂+S→CaS+2C (8)

The resulting substances, including magnesium sulfide (MgS) and calcium sulfide (CaS), are not soluble in molten iron and will therefore be in solid form (e.g., as solid particles) that can be more readily removed at the desulfurization unit 120 and/or further downstream. As discussed further herein, reducing the sulfur content can increase the quality of the GMU product and/or allow the production process to be continuous. After the desulfurization process, the torpedo car 102 can transfer the molten iron from the desulfurization unit 120 to the granulator units 130. In some embodiments, as indicated by the dashed arrow, the desulfurization unit 120 is bypassed and the molten iron is transferred directly from the furnace unit 110 to the granulator units 130. Notably, conventional facilities may not include a desulfurization unit or may otherwise lack the ability to desulfurize molten iron. One reason for this is that conventional steelmaking facilities directly feed molten iron from blast furnaces to basic oxygen furnaces, and opt to granulate the molten iron only when the basic oxygen furnaces are down. Because producing GPI is a backup operation for such facilities, the added complexity and costs associated with establishing desulfurization equipment may not be economical.

In some embodiments, the temperature of the molten iron is within a predetermined range prior to reaching the granulator units 130. For example, maintaining the molten iron in a sufficiently fluid state can better ensure the formation of uniform granules and help avoid premature solidification, which can lead to irregular granule shapes and sizes. In some embodiments, the system includes one or more heaters 115 before and/or after the desulfurization unit 120, e.g., to reheat the molten iron within the torpedo car 102. For example, if the temperature of the molten iron is below a threshold temperature value, the heater 115 can be used to raise the temperature of the molten iron in the torpedo car 102 to be within a desired temperature range. The threshold temperature value can vary between different compositions, and can be between 2300-2500° F., between 2300-2400° F., or between 2340-2350° F. In some embodiments, the heater 115 comprises one or more oxygen lances.

The torpedo car 102 can transfer the molten iron to one of the granulator units 130. While FIG. 1 illustrates two granulator units 130, it will be understood that the system 100 can include one, three, four, five, six, or more granulator units 130. The granulator units 130 can each include a granulation reactor that receives and granulates molten iron to form granulated products. For example, the granulation reactor can include a cavity that holds water, and the molten iron can be transferred (e.g., poured, sprayed) onto a target of the reactor holding the water. The water can be maintained at a sufficiently low temperature by the cooling system 140 (e.g., cooled directly by pumping the water between the granulator units 130 and the cooling system 140, cooled indirectly by pumping a coolant separate from the water that receives the molten iron). In some embodiments, the granulator units 130 each includes one or more components for controlling the flow of molten iron from the torpedo car 102 to the granulation reactor. As one of ordinary skill in the art will appreciate, flow control can affect the shape, size, and quality of the granulated products. The granulator units 130 can also include a dewatering assembly for drying the granulated products from the granulation reactor to output GMU. The granulator units 130 can further include a classifier assembly for filtering the filtrate from the dewatering assembly to output fines.

The system 100 can further include a product handing unit 150 to receive the GMU output by the granulator units 130 (e.g., by the dewatering assembly), and a loadout 155 downstream of the product handling unit 150. Additionally, the system 100 can further include a fines handling unit 160 to receive the fines output by the granulator units 130 (e.g., by the classifier assembly), and a loadout 165 downstream of the fines handling unit 160. In some embodiments, the product handling unit 150 and/or the fines handling unit 160 each includes one or more conveyor belts, diverters, stockpile locations, etc. The system 100 can additionally include a torpedo preparation unit 170 that can remove slag and/or kish from the torpedo car 102. For example, the torpedo car 102, after delivering the molten iron to the granulator units 130, can proceed to the torpedo prep unit 170 to be cleaned or otherwise prepared for the next cycle of transferring molten iron. The removed slag can be subsequently transferred to a slag processor 175. The system 100 can further include a scrap storage 180 that can receive thin pig and/or iron skulls from the granulator units 130.

As shown in FIG. 1, the fines at the loadout 165, slag and/or iron from the granulator units 130, and/or the thin pig and/or iron skulls at the scrap storage 180 can be fed back into the furnace unit 110 as recycled materials. In some embodiments, the recycled materials are processed (e.g., pelletized) prior to being fed into the furnace unit 110. Furthermore, emissions from various components of the system 100 can be collected and directed towards a dust collection unit 190 (e.g., a baghouse, a scrubber, etc.). In FIG. 1, for example, the emissions from the desulfurization unit 120 and the granulator units 130 are directed to a first dust collection unit 190a, and the emissions from the torpedo prep unit 170 are directed to a second dust collection unit 190b. Each of the dust collection units 190 can filter the emissions to remove dust therefrom so that clean waste gas is sent to stacks (not shown) to be released into the atmosphere, and the removed dust can be directed to further processing.

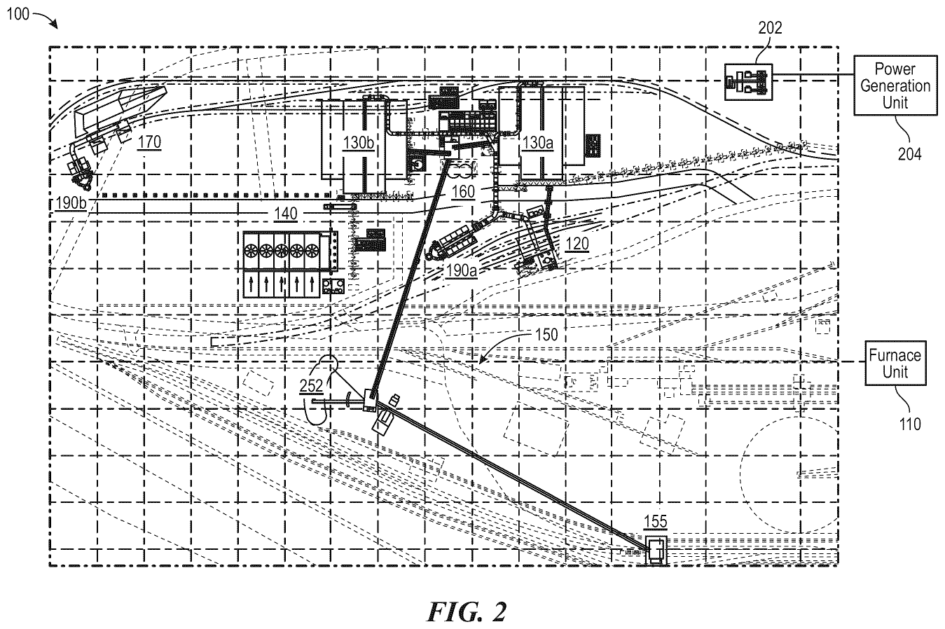

FIG. 2 is a plan view of the continuous GMU production system 100. It will be appreciated that the plan view illustrated in FIG. 2 is merely one example, and that the components of the system 100 can be arranged differently in other embodiments. As shown, the system 100 can further include an electrical building 202 and a power generation unit 204 for providing electrical power to the system 100. As discussed further herein, one or more of the components of the system 100 can be powered electrically as opposed to, e.g., hydraulically. The furnace unit 110 can be located away from many of the other components of the system 100. The torpedo car 102 or other transfer vessel (not shown) can transfer the molten iron from the furnace unit 110 to the desulfurization unit 120 along tracks illustrated in dashed lines.

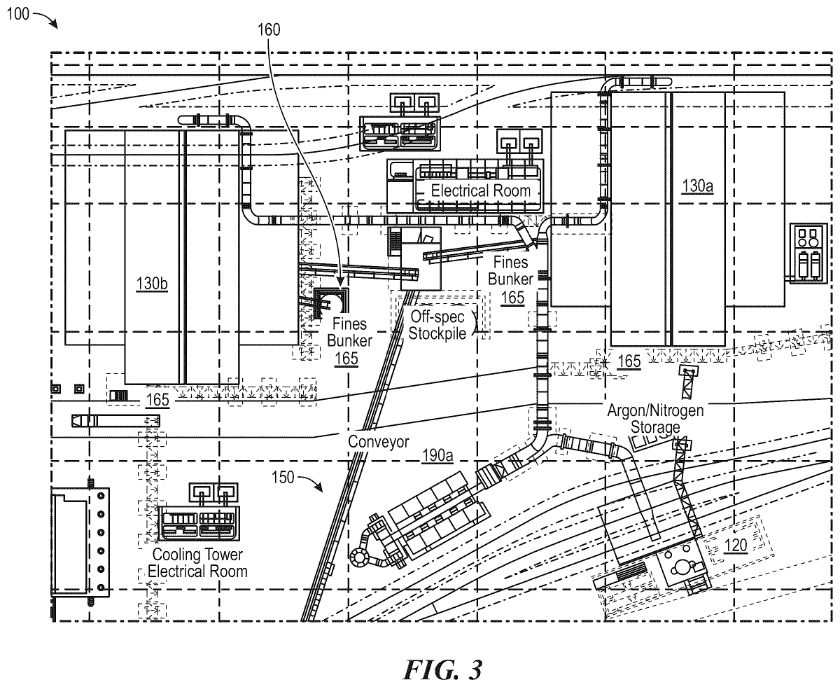

Referring momentarily to FIG. 3, which is an enlarged plan view of the system 200, the desulfurization unit 120 can desulfurize the molten iron while the molten iron remains in the torpedo car 102. Once the molten iron is desulfurized, the torpedo car 102 can continue along the tracks to the granulator units 130. The torpedo car 102 can deliver the molten iron to either of the first granulator unit 130a or the second granulator unit 130b depending on, e.g., the availability of each of the granulator units 130. The GMU produced by each of the granulator units 130 can be transferred downstream via one or more conveyor belts that form part of the product handling unit 150. The fines produced by each of the granulator units 130 can be transferred to fines bunkers located adjacent to the granulator units 130 and ultimately sent to the loadout(s) 165. As shown in FIG. 3, the first dust collection unit 190a can be connected to each of the desulfurization unit 120 and the granulator units 130 via pipes to collect emissions therefrom.

Returning to FIG. 2, the cooling system 140 can be located adjacent to the granulator units 130 to provide cooling thereto as needed. The product handling unit 150 can include a stockpile area 252 for storing GMU products. One or more conveyor belts can extend between each of the granulator units 130 and the stockpile area 252, and between the stockpile area 252 and the loadout 155. In some embodiments, the loadout 155 comprises a building at which a desired quantity of GMUs can be measured and transferred to a railcar or other transfer vehicle. In some embodiments, the GMUs is subsequently transferred to an electric arc furnace (not shown) for steel production. The torpedo car 102, after delivering the molten iron to the granulator units 130, can continue along the tracks to reach the torpedo prep unit 170. As discussed above with reference to FIG. 1, the torpedo prep unit 170 can facilitate removal of slag and/or kish from the torpedo car 102. The second dust collection unit 190b can be connected to the torpedo prep unit 170 via pipes to collect emissions therefrom.

Referring to FIGS. 1-3 together, the system 100 is expected to be able to continuously produce GMU, unlike conventional GMU production systems. First, the inclusion of the desulfurization unit 120 provides several advantages. For example, GMUs with lower sulfur content produces less slag when melted at an electric arc furnace downstream, saving associated time, costs, and energy consumption. The use of GMUs with lower sulfur content can also ease maintaining the desired chemical composition and temperature, reducing the frequency of adjustments and interruptions during the melting cycle. Lower sulfur levels can also result in less wear and tear on other components of the system, reducing maintenance needs and associated downtime.

Second, the inclusion of a plurality of granulator units 130 allows molten iron to be granulated at separate granulator units in parallel. The granulator units 130 can also serve as backups for one another in case one of the granulator units 130 is down (e.g., due to malfunctioning components, maintenance, etc.). Furthermore, in some embodiments, the various components of the granulator units 130 are modular. For example, each of the components can be easily and independently removed (e.g., for maintenance) and/or replaced (e.g., via an overhead crane) without impacting operation of the other components.

### III. Systems and Methods of Loading GMUs into Railcars

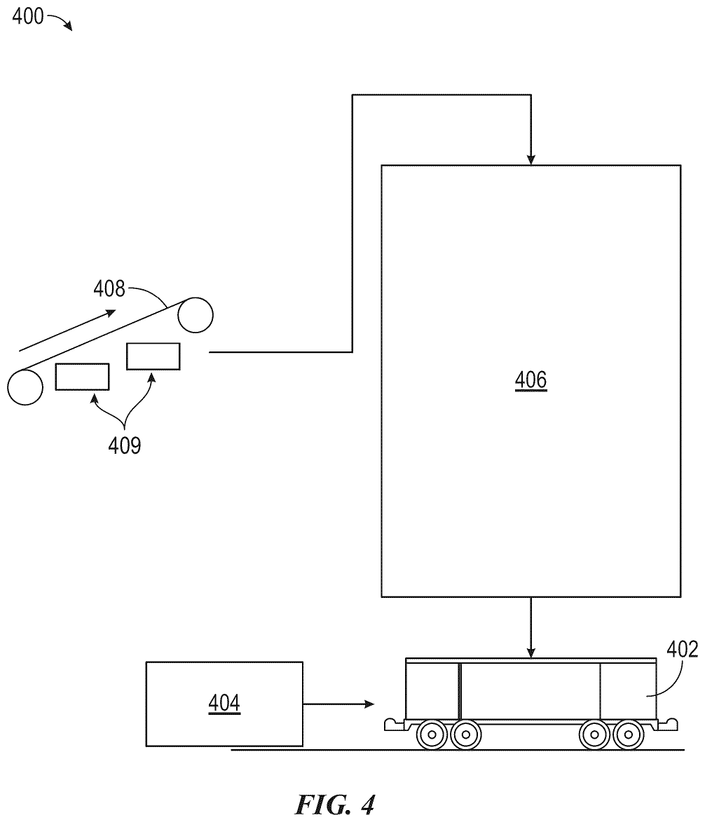

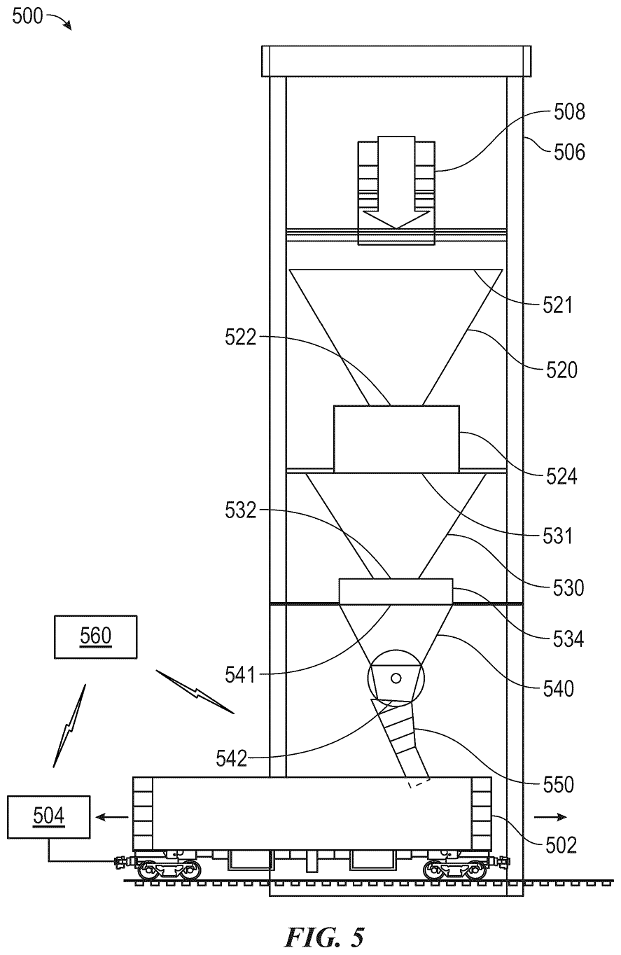

FIG. 4 is a schematic illustration of a system 400 for loading GMUs into one or more railcars 402 in accordance with embodiments of the present technology. In some embodiments, one or more components of system 400 are generally similar to/identical to loadout 155 discussed with reference to FIG. 1. For example, system 400 includes a conveyer mechanism 408 (also referred to as an inclined conveyer) and a housing unit 406. The housing unit 406 is configured with various components (discussed further with reference to FIGS. 5-9) to determine a desired quantity of GMUs before transferring the GMUs to the one or more railcars 402. In some embodiments, system 400 further includes a railcar movement mechanism 404 (e.g., a railcar mover) configured to move the one or more railcars 402 throughout loading of the railcars 402.

In some embodiments, the conveyer mechanism 408 is inclined to provide the GMUs to components in the housing unit 406 that are positioned above the one or more railcars 402. In some embodiments, the inclined conveyer 408 includes a plurality of chevron-shaped conveyor segments that enhance the grip and movement of GMUs along the inclined conveyer 408 path, preventing slippage and ensuring a consistent flow of material. In some embodiments, the conveyor segments are reinforced with a hardened material (e.g., plating, armor, and the like), and/or are comprised of one or more of the following materials: carbon steel, abrasion-resistant (AR) steel, Hardox®, polyurethane, silicon carbide, tungsten carbide, titanium alloy, and the like. The reinforced plating and/or wear-resistant composition of the conveyer segments provides durability and strength to withstand the erosion and wear from GMUs.

In some embodiments, the inclined conveyer 408 includes one or more catch trays 409 positioned at select locations below the inclined conveyor 408. The catch trays 409 collect any GMUs that may fall off the conveyor during transport, preventing material loss and maintaining a clean and safe working environment. The catch trays 409 can be reinforced and/or composed of hardened material similar to the conveyer segments.

FIG. 5 is partially schematic illustration of a system 500 for loading GMUs into one or more railcars 502 in accordance with embodiments of the present technology. In some embodiments, the system 500 includes features generally similar/identical to features of the system 400 of FIG. 4. As shown in FIG. 5, the housing unit 506 contains various components for weighing and determining a desired quantity of GMUs, as well as guiding GMUs into one or more railcars 502. The conveyor 508 is configured to transport GMUs to an upper region of the housing unit 506 and discharge it into a surge bin 520 and weigh bin 530, both of which are coupled to the housing unit 506. The surge bin 520 is positioned above the weigh bin 530, and is configured to act as a buffer and/or surge volume, collecting excess GMUs that build up in the weigh bin 530. A surge bin inlet 521 collects GMUs from the conveyor 508 and helps it to a surge bin outlet 522, which is positioned below the inlet 521. In some embodiments, the surge bin 520 is shaped based on the angle of repose of the product being loaded in the railcar (e.g., GMUs, GPI, etc.). That is, the surge bin 520 can be shaped such that an angle is formed between the body of the surge bin 520 and a plane of the surge bin inlet 521 and/or surge bin outlet 522. Shaping the surge bin 520 based on the angle of repose helps prevent the unwanted buildup of product in the surge bin 520. In some embodiments, the angle can range between 15-30 degrees, 30-45 degrees, 45-60 degrees, 60-75 degrees, or 75-90 degrees relative to plane of the surge bin inlet 521 and/or outlet 522, or can be at least 25 degrees, 30 degrees, 35 degrees, 40 degrees, 45 degrees, 50 degrees, 55 degrees, 60 degrees, 65 degrees, 70 degrees, 75 degrees, 80 degrees, or 85 degrees, or any incremental value therebetween (e.g., at least 33 degrees) relative to the surge bin inlet 521 and/or outlet 522. In some embodiments, the angle of repose can be determined using one or more methods including: a tilting box (e.g., slowly tilting a box until the product begins to slide in bulk and measuring the tilt angle), a fixed funnel (e.g., pouring the product through a funnel to form a cone), a static or revolving cylinder (filling a cylinder with the product and measuring the angle of the product against the wall of the cylinder), and the like. A surge bin gate 524 (e.g., a clamshell gate, a slide gate, and the like) is positioned below the surge bin outlet 522, and can move between a closed position, where GMUs are held in the surge bin 520, and an open position, where GMUs are discharged via gravity into the weigh bin 530 (through the surge bin outlet 522), positioned below the surge bin gate 524.

In some embodiments, the weigh bin 530 is configured to receive GMUs at a weigh bin inlet 531, which guides collects and guides GMUs to the weigh bin outlet 532. In some embodiments, the weigh bin 530 is shaped based on the angle of repose of the product being loaded in the railcar (e.g., GMUs, GPI, etc.). That is, the weigh bin 530 can be shaped such that an angle is formed between the body of the weigh bin 530 and a plane of the weigh bin inlet 531 and/or weigh bin outlet 532. Shaping the weigh bin 530 based on the angle of repose helps prevent the unwanted buildup of product in the weigh bin 530. In some embodiments, the angle can range between 15-30 degrees, 30-45 degrees, 45-60 degrees, 60-75 degrees, or 75-90 degrees relative to plane of the weigh bin inlet 531 and/or outlet 532, or can be at least 25 degrees, 30 degrees, 35 degrees, 40 degrees, 45 degrees, 50 degrees, 55 degrees, 60 degrees, 65 degrees, 70 degrees, 75 degrees, 80 degrees, or 85 degrees, or any incremental value therebetween (e.g., at least 33 degrees) relative to the weigh bin inlet 531 and/or outlet 532.

A weigh bin gate 534 (e.g., a clamshell gate, a slide gate, and the like) is positioned below the weigh bin outlet 532. The weigh bin gate 534 can move between a closed position, where GMUs are held in the weigh bin 530 (for example, to determine the weight of the GMUs and/or identify if the weight of the GMUs meets a target weight of the GMUs), and an open position, where GMUs are discharged via gravity past the weigh bin gate 534.

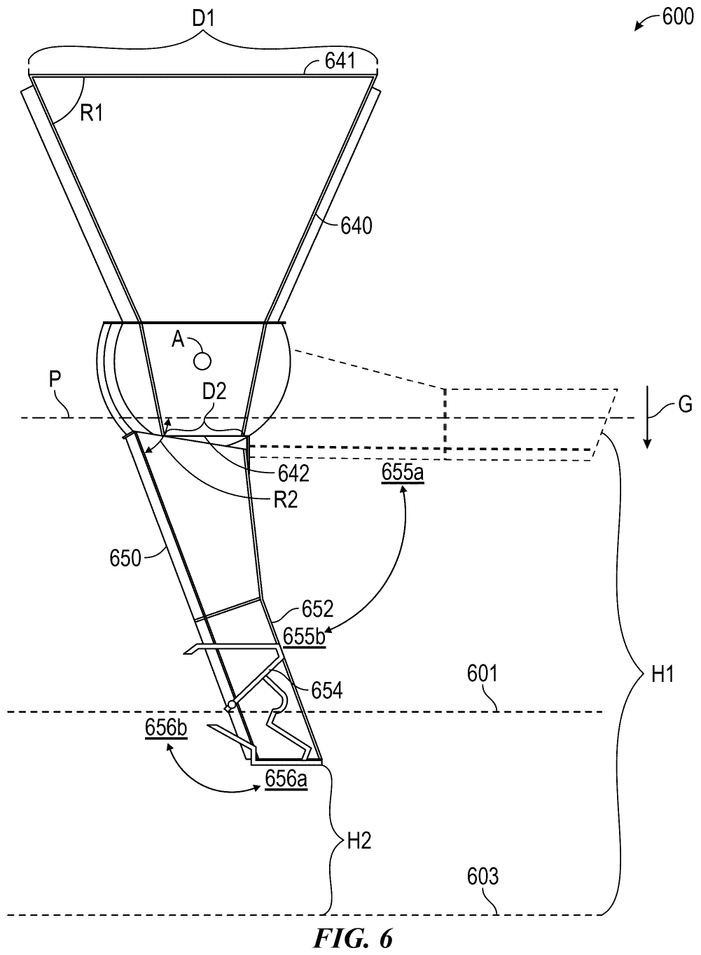

In some embodiments, a hopper 540 is configured to receive GMUs discharged through the weigh bin gate 534 at a hopper inlet 541, which collects and guides GMUs to the hopper outlet 542 positioned below the inlet 541. In some embodiments, the hopper inlet 541 has a first diameter (see D1 of FIG. 6) and the hopper outlet 542 has a second diameter (see D2 of FIG. 6) less than the first diameter D1. The hopper outlet 542 discharges the GMUs into a chute 550.

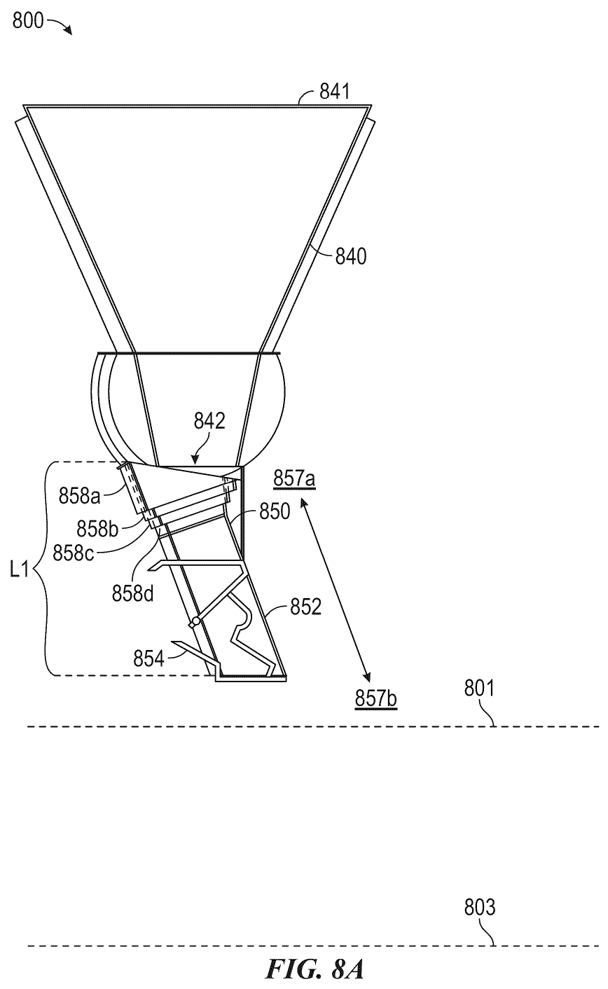

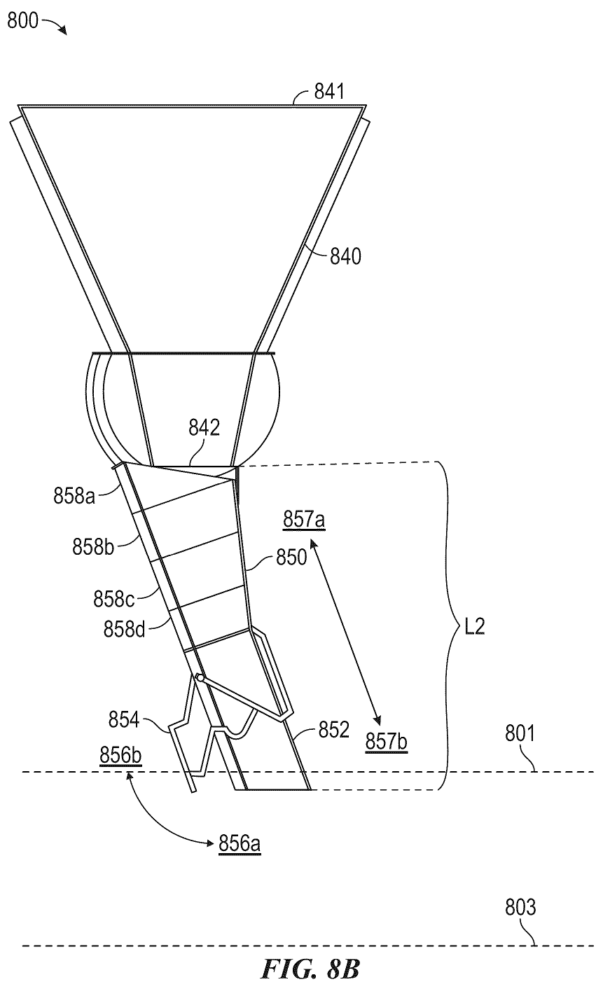

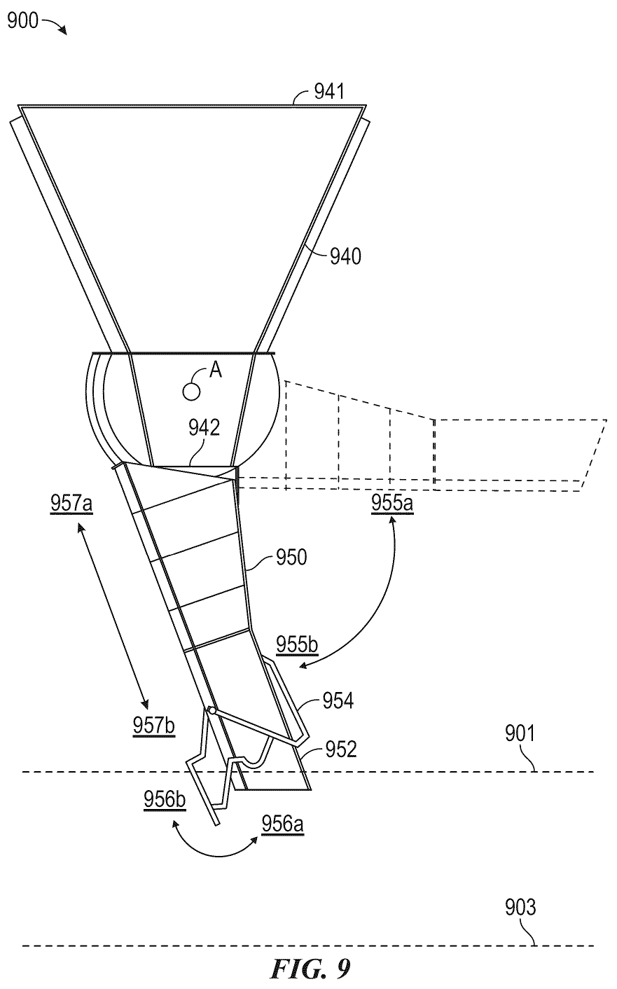

The chute 550 is configured to receive GMUs discharged through the hopper outlet 542 and to direct the GMUs into a railcar 502 (e.g., a floor of the railcar 502) positioned below the chute 550. In some embodiments, the chute 550 includes an articulating feature, discussed further with reference to FIGS. 6, 7, and 9, and is rotatable relative to the hopper 540 about an axis. In some embodiments, the chute 550 includes telescoping features, discussed further with reference to FIGS. 8A-9. Some embodiments include both a telescoping feature and an articulating feature, discussed further with reference to FIG. 9.

In some embodiments, the system 500 may include a railcar movement mechanism 504 configured to move the one or more railcars 502 during the loading of GMUs. For example, railcar movement mechanism 504 can be a railcar mover.

In some embodiments, a controller 560 controls the operation of one or more of the components of system 500. For example, controller 560 can control the operation of the weigh bin gate 534 and surge bin gate 524 (e.g., opening and closing positions), as well as rotation and/or telescoping of the chute 550. In some embodiments, the controller 560 can be configured to interface with a user and/or coordinate the operation of the system 500. In some embodiments, the controller 560 includes one or more hardware and software components for controlling operation of the system 500. For example, the controller 560 can include one or more processors (e.g., central processing unit(s) (CPU(s)), graphics processing unit(s) (GPU(s)), holographic processing unit(s) (HPU(s)), etc.) and memory (e.g., volatile storage, non-volatile storage) for storing instructions to be executed by the one or more processors. The controller 560 can include or be in the form of one or more controllers, one or more controller circuits, or the like, or a combination thereof. Examples of controllers may include a microcontroller, a programmable logic controller (PLC), a digital signal controller (DSC), a motor controller, or a combination thereof.

In operation, the conveyor 508 transports GMUs to the upper region of the housing unit 506, where it discharges the GMUs into the surge bin 520. The surge bin 520 collects GMUs and directs them through the surge bin inlet 521 to the surge bin outlet 522. If the surge bin gate 524 is open, GMUs pass through the surge bin outlet 522 and surge bin gate 524 to the weigh bin 530. If the surge bin gate 524 is closed, GMUs collect and are maintained in the surge bin 520 until the surge bin gate 524 is opened. Once GMUs pass through the surge bin 520, the weigh bin 530 receives the GMUs at the weigh bin inlet 531 and guides them to the weigh bin outlet 532. The weigh bin gate 534, located below the weigh bin outlet 532, is kept in a closed position to allow GMUs to collect in the weigh bin 530. While in the weigh bin 530, the weight of the GMUs in the weigh bin 530 can be measured and/or determined. In some embodiments, once the weight of the GMUs meets the target weight of the GMUs (representative of a desired quantity of GMUs to be discharged into the railcar 502), the weigh bin gate 534 can move to an open position, discharging the GMUs via gravity past the weigh bin gate 534. In some embodiments, the surge bin gate 524 is shut prior to measuring and/or determining the weight of the GMUs in the weigh bin 530, to assist with accurate weight determination. In some embodiments, the surge bin gate 524 is shut after measuring and/or determining the weight of the GMUs to prevent unwanted GMUs from escaping the surge bin 520 and/or weigh bin 530 into the railcar 502.

The hopper 540 receives the GMUs discharged from the weigh bin 530 at the hopper inlet 541 and guides them to the hopper outlet 542. The chute 550 receives the GMUs from the hopper outlet 542 and guides them to the railcar 502. In some embodiments, during the loading process, the railcar movement mechanism 504 repositions the railcar 502 to ensure even distribution of the GMU load.

The described apparatus offers several benefits for loading GMUs into railcars. The surge bin 520, surge bin gate 524, weigh bin 530, and weigh bin gate 534 ensure precise measurement and controlled discharge of GMUs, reducing spillage and waste and ensuring that the desired quantity of GMU is discharged to the railcar 502. The surge bin 520 acts as a buffer and/or surge volume for the weigh bin 530, maintaining a steady supply of GMUs to the weigh bin 530 and allowing for accurate weighing and efficient discharge. The generally-tapered shape of the hopper 540 ensures smooth and consistent discharge of GMUs from the weigh bin 530 to the chute 550. The shape of the hopper 540 further reduces the speed and/or force of GMUs as they discharge from the weigh bin 530. The chute 550 further reduces the speed and/or force of GMUs as they discharge into the railcar 502 by providing an angled descent for the GMUs, and by positioning the GMUs closes to the floor of the railcar 502 once they leave the chute 550.

FIG. 6 is a partially schematic side view of an articulating apparatus 600 in accordance with embodiments of the present technology. In the present embodiments, the articulating apparatus 600 includes a hopper 640 and an articulating chute 650. The hopper 640 includes a hopper inlet 641 of a first diameter D1, and a hopper outlet 642 of a second diameter D2, configured to guide GMUs into the chute 650. In some embodiments, D2 is less than D1. In some embodiments, the hopper 640 is shaped based on the angle of repose of the product being loaded in the railcar (e.g., GMUs, GPI, etc.). That is, the hopper 640 can be shaped such that an angle R1 is formed between the body of the hopper 640 and a plane of the hopper inlet 641 and/or hopper outlet 642. Shaping the hopper 640 based on the angle of repose helps prevent the buildup of product in the hopper 640. In some embodiments, the angle R1 can range between 15-30 degrees, 30-45 degrees, 45-60 degrees, 60-75 degrees, or 75-90 degrees relative to plane of the hopper inlet 641 and/or outlet 642, or can be at least 25 degrees, 30 degrees, 35 degrees, 40 degrees, 45 degrees, 50 degrees, 55 degrees, 60 degrees, 65 degrees, 70 degrees, 75 degrees, 80 degrees, or 85 degrees, or any incremental value therebetween (e.g., at least 33 degrees) relative to the hopper inlet 641 and/or outlet 642.

The chute 650 is configured guide GMUs into a railcar (e.g., any of the one or more railcars described throughout this document) and to articulate and/or rotate about an axis A of the hopper 640 such that the chute achieves a raised or lowered position. That is, in some embodiments, the chute 650 can be rotated in a first (e.g., raised) direction 655a such that a longitudinal plane P of the chute 650 is approximately perpendicular to the direction of gravity G, and where an end section 652 (also referred to as an end portion) is at a first height H1 relative to a railcar floor 603. The chute 650 can also be rotated in a second (e.g., lowered) direction 655b such that the chute 650 achieves an angle R2 relative to the plane P when the end section 652 is positioned at a second height H2 closer to the railcar floor 603. In some embodiments, the second direction 655b can result in the end section 652 being positioned below a plane of the railcar side walls 601.

In some embodiments, the angle R2 of the chute 650 is based on the angle of repose of product being loaded into the railcar (e.g., GMUs, GPI, etc.). In some embodiments, the angle R2 can range between 15-30 degrees, 30-45 degrees, 45-60 degrees, 60-75 degrees, or 75-90 degrees relative to the longitudinal plane P, or can be at least 25 degrees, 30 degrees, 35 degrees, 40 degrees, 45 degrees, 50 degrees, 55 degrees, 60 degrees, 65 degrees, 70 degrees, 75 degrees, 80 degrees, or 85 degrees, or any incremental value therebetween (e.g., at least 33 degrees) relative to the longitudinal plane P. Angling of the chute 650 assists with preventing unwanted buildup of product in the chute 650, and reduces the velocity and/or force with which the product exits the chute 650, ultimately reducing the impact force of the product on the railcar.

In some embodiments, the chute 650 includes a chute gate 654 coupled to the end section 652, and distal to the hopper 640. The chute gate 654 is moveable between a closed position 656a and an open position 656b. The chute gate 654 prevents GMUs that unintentionally escape from the weigh bin and/or surge bin (described further with reference to FIG. 5) from exiting the chute 650, maintaining safety for personnel below the chute 650 and mitigating unwanted spillage or loss of product.

In some embodiments, the chute 650 is comprised of a rigid material, such as steel, other metal/metal alloys, and polyurethane, to improve the durability of the chute 650. In some embodiments, the chute 650 is made of a flexible material. In such embodiments, the chute 650 can remain stationary as the railcar pulls away after loading, simply sliding out of the railcar based on the movement of the railcar away from the chute 650.

The benefits of an articulating chute 650 as disclosed include positioning the end section 652 closer to the floor 603 of the railcar compared to conventional technologies. By lowering the end section 652 relative to the floor 603, the speed and force with which GMUs impinge on the railcar floor 603 is substantially reduced. This minimizes damage to the railcar and increases longevity of the railcar. Angling the chute 650 (e.g., angle R2) further slows the discharge of GMUs through the chute 650, ensuring that the GMUs exit the chute at a relatively low velocity, reducing the impact force on the railcar floor 603.

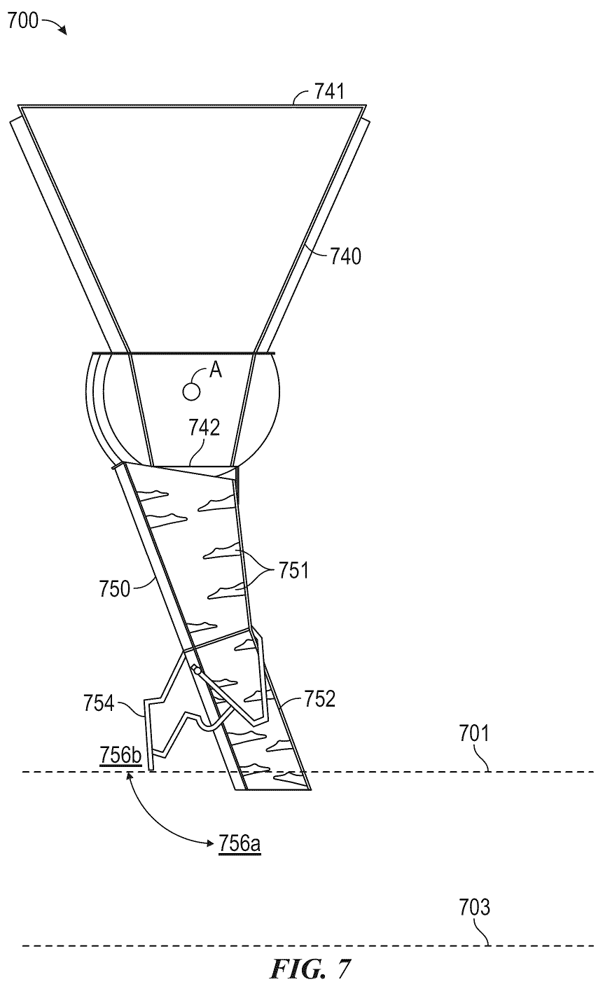

FIG. 7 is a partially schematic side view of an articulating apparatus 700 in accordance with additional embodiments of the present technology. In some embodiments, articulating apparatus 700 includes features similar/identical to the articulating apparatus 600 of FIG. 6. Accordingly, like numbers refer to like features.

One of the principle differences between articulating apparatus 700 and articulating apparatus 600 is the inclusion of one or more baffle elements 751 along at least a portion of the interior of the articulating chute 750. The baffle elements 751 are configured to at least partially disrupt the flow of GMUs through the articulating chute 750, thereby reducing the velocity and/or force of the GMUs when exiting chute 750 and ultimately preventing/reducing damage to the railcar (e.g., the railcar floor 703). In some embodiments, the baffle elements 751 are comprised of a hardened material, such as carbon steel, abrasion-resistant (AR) steel, Hardox®, polyurethane, silicon carbide, tungsten carbide, titanium alloy, and the like. In some embodiments, the baffle elements 751 are comprised of a flexible material, such as rubber and the like. In some embodiments the baffle elements 751 are arranged in a staggered pattern. In some embodiments, the baffle elements 751 are comprised of deflector plates and/or deflector belts. In some embodiments, the baffle elements 751 are comprised of one or more trays or boxes (also referred to as a “rock box”) configured to hold materials, such that each tray or box has an open top and can be filled with granulated material, such as GMU, GI, GPI, GS, aggregate rock, or the like. GMUs passing through the chute 750 impact the granulated layer of the one or more of the rock boxes, slowing and/or stopping the descent of at least some of the GMUs. In some embodiments, the one or more boxes are initially empty (e.g., no layer of granulated material), and an initial portion of the GMUs passing through the chute 750 becomes trapped in the boxes and forms the layer of granulated material, which subsequently slows and/or stops the descent of at least some of the other GMUs passing through the chute 750. As it will be appreciated, one skilled in the art would recognize that the baffle elements 751 can be comprised of a variety shapes, materials, and arrangements.

FIG. 8A is a partially schematic side view of a telescoping apparatus 800 in a retracted configuration 857a in accordance with embodiments of the present technology. FIG. 8B is a partially schematic side view of the telescoping apparatus 800 of FIG. 8A in an extended configuration 857b in accordance with embodiments of the present technology. In some embodiments, telescoping apparatus 800 includes features generally similar/identical to articulating apparatus 600 of FIG. 6. Accordingly, like numbers refer to like features.

Referring to FIGS. 8A and 8B together, in the present embodiments, telescoping apparatus 800 includes a hopper 840 with a hopper inlet 841 and a hopper outlet 842 positioned below the hopper inlet 841. The hopper 840 is configured to receive GMUs at the inlet 841 and to guide GMUs to a telescoping chute 850. Telescoping chute 850 is comprised of one or more telescoping segments 858a-d, which are each configured to extend away from the hopper 840. That is, each of the telescoping segments 858a-d is configured to extend from a first position 857a to a second position 857b, where the first position 857a is more proximate the hopper 840 than the second position 857b, and where the first position 857a is more distal from a railcar floor 803 than the second position 857b. Thus, when the telescoping segments 858a-d are extended, the end portion 852 of chute 850 is positioned closer to the floor 803. In some embodiments, the telescoping chute 850 is a first length L1 when the telescoping segments 858a-d are retracted, and a second length L2 when the telescoping segments 858a-d are extended, where L2 is a greater length than L1. In some embodiments, when the telescoping chute 850 is extended to L2 (e.g., the telescoping segments 858a-d are at position 857b), the end portion 852 is positioned below the plane 801 of the sidewalls of the railcar. In some embodiments, the telescoping chute 850 is angled based on an angle of repose (e.g., as described with reference to FIG. 6), in one or more of the extended position 857b and/or retracted position 857a. By positioning the end portion 852 below plane 801 and/or closer to floor 803, the impact force of GMUs discharging from the chute 850 is significantly reduced, mitigating and/or preventing damage to the railcar.

FIG. 9 is a partially schematic side view of an articulating apparatus 900 configured to telescope in accordance with embodiments of the present technology. In some embodiments, the articulating apparatus 900 includes features generally similar/identical to any of the articulating apparatuses and telescoping apparatuses described in this document. For example, apparatus 900 includes the articulating/rotating features described in FIG. 6, and the telescoping features of FIGS. 8A and 8B. Accordingly, like numbers refer to like features.

In the present embodiment, the chute 950 is configured to articulate and/or rotate about axis A of the hopper 940. In some embodiments, the chute 950 is further in first position 957a, in which one or more telescoping segments (not pictured) of chute 950 are retracted. The chute 950 can be rotated from a first (e.g., raised) direction 955a to a second (e.g., lowered) direction 955b while retracted in first position 957a. The chute 950 can be rotated so as to align with an angle associated on and/or based on the angle of repose of, for example, GMU. Once the chute 950 is rotated in direction 955b and is aligned with the desired angle, the chute 950 can be extended to second position 957b. In some embodiments, the combination of rotation in second direction 955b and extension to position 957b positions end section 952 proximate railcar floor 903 relative to rotation in first direction 955a and retraction to position 957a.

This combination of rotation and extension/retraction provides flexibility in the manner of use of chute 950, while providing a mechanism for slowing the descent of GMUs through the chute 950. For example, an operator can determine that simple retraction to position 957a is appropriate for a given working condition (e.g., withdrawing chute 950 to above the plane 901 in order to replace a full railcar with an empty railcar). In another example, an operator can determine that rotation in direction 955a is warranted to both withdraw chute 950 from plane 901 and to provide additional safety from unintentionally spilled GMUs (e.g., from the weigh bin), since the chute 950 can be positioned approximately perpendicular to the direction of gravity and thus block falling GMUs. In an additional example, both retraction to position 957a and rotation in direction 955a may be warranted when the chute 950 is expected to be inactive for a period of time.

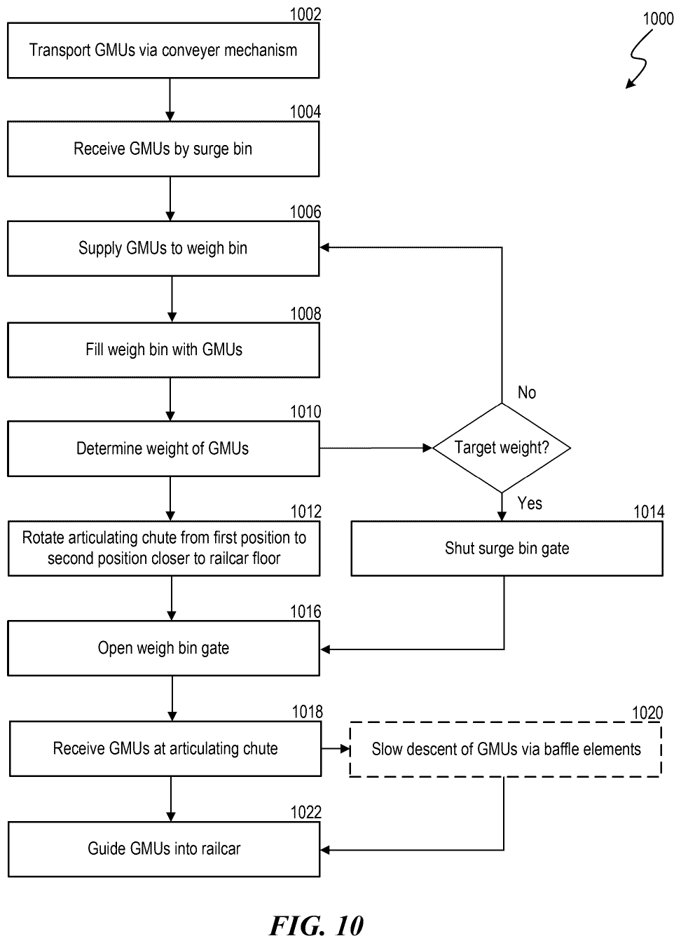

FIG. 10 is a flow diagram of a method 1000 of loading GMUs into railcars via an articulating apparatus in accordance with embodiments of the present technology. In some embodiments, parts of method 1000 are performed and/or carried out by any of the systems described throughout this document (e.g., systems 400, and 500 of FIGS. 4 and 5, respectively). In some embodiments, parts of method 1000 are performed and/or carried out using any of the articulating apparatuses described throughout this document (e.g., apparatuses 600, 700, and 900 of FIGS. 6, 7, and 9, respectively).

At block 1002, GMUs are transported via a conveyer mechanism to a housing unit. The housing unit defines a structure that includes, in some embodiments, a surge bin, a surge bin gate, a weigh bin, a weigh bin gate, a hopper, and an articulating chute. In some embodiments, one or more railcars is positioned at least partially in the structure, below the other components of the structure. In some embodiments the conveyer mechanism is inclined to provide GMUs to a high point of the housing unit and/or components of the housing unit structure. In some embodiments, the conveyer mechanism includes a plurality of chevron-shaped conveyor segments. In some embodiments, the conveyor segments are reinforced with a hardened material and/or are comprised of one or more of the following materials: carbon steel, abrasion-resistant (AR) steel, Hardox®, polyurethane, silicon carbide, tungsten carbide, titanium alloy, and the like. In some embodiments, the inclined conveyer includes one or more catch trays positioned at select locations below the inclined conveyor (e.g., personnel transit areas and walkways).

At block 1004, GMUs are received by the surge bin at or near the high point of the housing unit where the conveyer mechanism transports the GMUs. For example, the surge bin can be positioned just below an edge of the conveyer mechanism such that, when GMUs are transported to the edge and/or beyond the edge of the conveyer mechanism, the surge bin catches the GMUs as they fall off of the conveyer mechanism. In some embodiments, the surge bin is positioned above the surge bin gate, the weigh bin, the hopper, the articulating chute, and the railcar. The surge bin is configured to guide the falling GMUs from an inlet of the surge bin to an outlet of the surge bin. In some embodiments the surge bin is shaped like a funnel, where the diameter of the inlet is greater than the diameter of the outlet, and the shape of the surge bin and guides the GMUs to the surge bin outlet as the GMUs descend. After passing through the surge bin outlet, the surge bin gate receives the GMUs. In some embodiments, the surge bin gate is positioned below the surge bin but above the weigh bin. In some embodiments the surge bin gate pre-positioned in an open position to allow GMUs exiting the surge bin to pass through the surge bin gate. In some embodiments the surge bin gate is pre-positioned in a closed or shut position, preventing GMUs from passing through the surge bin gate and holding/maintaining the GMUs in the surge bin.

At block 1006, GMUs are supplied to the weigh bin. In some embodiments, if the surge bin gate was in a closed position, the surge bin gate is opened and GMUs descend into the weigh bin. In some embodiments, the surge bin gate is pre-positioned open and GMUs descend into the weigh bin as the GMUs discharge from the surge bin outlet.

At block 1008, the weigh bin is filled with GMUs (e.g., via the surge bin outlet). The weigh bin is positioned above the weigh bin gate, which is positioned at a weigh bin outlet. In some embodiments the weigh bin gate is pre-positioned and/or initially in a shut or closed position such that GMUs being received and descending through the weigh bin build up to form a pile.

At block 1010, the weight of the GMUs in the weigh bin is determined. For example, In some embodiments, the weight of the GMUs in the weigh bin is determined through one or more sensors (e.g., load cells) configured to determine the force and/or weight of the GMUs in the weigh bin. In some embodiments the one or more sensors provide a signal to a controller (including processors) which performs a weight calculation. In some embodiments, a target weight of the GMUs (e.g., 100 short tons, 75 short tons, 50 short tons) is established, and the determined weight of the GMUs in the weigh bin is compared to a target weight of the GMUs. If the determined weight does not meet the target weight, additional GMUs are supplied to the weigh bin (e.g., block 1006). In some embodiments, the comparison of the determined weight to the target weight is performed automatically, for example, by the controller and/or other electronics. In some embodiments, the comparison is performed manually by an operator. In some embodiments the target weight is based at least in part on a gross weight limit of a rail line and/or railcar (e.g., a weight limit of 200,000 pounds, 250,000 pounds, 268,000 pounds, 286,000 pounds, etc.). In some embodiments the determination of the weight of the GMUs in the weigh bin occurs continuously as the weigh bin is filled. In some embodiments, the determination of the weight of the GMUs occurs iteratively, where the surge bin gate is shut at various points (e.g., block 1014, discussed below) to stop the descent of GMUs into the weigh bin. While the surge bin gate is shut, the weight of the GMUs is determined and compared to the target weight.

In some embodiments, the weight of the GMUs is determined after being discharged into the railcar (e.g., block 1010 is omitted). In such embodiments, the weight of the GMUs in the railcar can, for example, be determined by positioning the railcar on a weighing mechanism configured to obtain the total weight of the railcar and loaded GMUs and/or the weight of the GMUs in the railcar less the weight of the railcar.

At block 1012, the articulating chute is rotated from a first position to a second position such that an exit and/or end section of the chute is positioned closer to the floor of the railcar. In some embodiments, the first position places a longitudinal plane of the articulating chute perpendicular to the direction of gravity. In some embodiments, the articulating chute is pre-positioned (e.g., pre-rotated) in the second position and block 1012 is omitted. In some embodiments the articulating chute is rotated during determination of the weight of the GMUs in the weigh bin. In some embodiments the articulating chute is rotated after the weight of the GMUs is determined. In some embodiments, rotation of the articulating chute is controlled at least in part by the controller (e.g., via one or more motor controllers).

If the determined weight does meet the target weight, in some embodiments, at block 1014, the surge bin gate is shut to stop the descent of GMUs into the weigh bin. At block 1016, the weigh bin gate is opened and the GMUs contained in the weigh bin are discharged, via gravity, through the weigh bin gate. In some embodiments, the weigh bin gate is opened based on whether the weight of the GMUs meets the target weight. In some embodiments, the weigh bin gate is opened based on whether the articulating chute has been rotated to the first or second position.

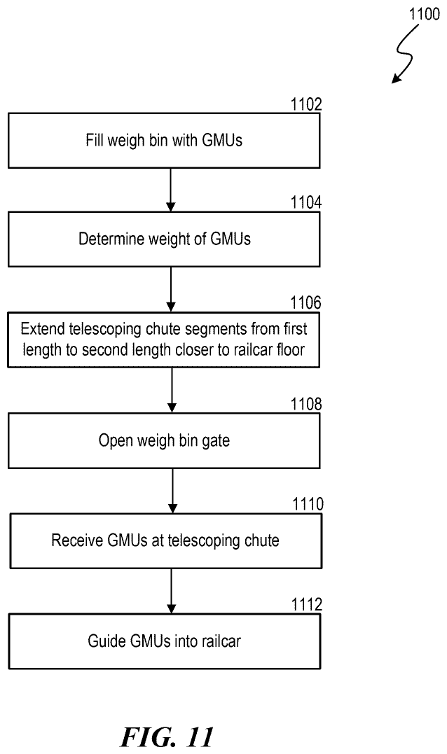

At block 1018, the GMUs are received by the articulating chute. In some embodiments GMUs descending through the weigh bin gate are first received by a hopper, which then guides the GMUs to the chute. In some embodiments the hopper is omitted and the GMUs are received directly by the articulating chute from the weigh bin. At block 1022, the GMUs are guided into the railcar via the articulating chute. In some embodiments, the articulating chute is angled (e.g., based on an angle of repose of GMU) such that the GMUs descending through the chute are slowed relative to a free fall velocity of the GMUs. In some embodiments, the articulating chute optionally includes one or more baffle elements configured to disrupt the descent of GMUs through the articulating chute. In such embodiments, the GMUs are further slowed via the baffle elements, as shown at optional block 1020. FIG. 11 is a flow diagram of a method 1100 of loading GMUs into railcars via a telescoping apparatus in accordance with embodiments of the present technology. In some embodiments, parts of method 1100 are performed and/or carried out by any of the systems described throughout this document (e.g., systems 400, and 500 of FIGS. 4 and 5, respectively). In some embodiments, parts of method 1100 are performed and/or carried out using any of the telescoping apparatuses described throughout this document (e.g., apparatuses 800 and 900 of FIGS. 8A-8B, and 9, respectively). In the present embodiments, one of the principal differences between method 1100 and method 1000 is that the method omits an articulating chute and includes a telescoping chute.

At block 1102, a weigh bin is filled with GMUs (e.g., via a conveyer mechanism providing GMUs which descends through a surge bin and surge bin gate into the weigh bin). At block 1104, a weight of the GMUs is determined (e.g., via one or more load cells and/or associated electronics). At block 1106, telescoping segments of the telescoping chute extend such that the telescoping chute (e.g., the end section of the telescoping chute) is positioned closer to the railcar floor. In some embodiments, extending the telescoping segments includes extending each of a first telescoping segment and a second telescoping segment, where the second telescoping segment is distal to the first telescoping segment and closer to the floor of the railcar than the first telescoping segment. In some embodiments, the telescoping segments are pre-positioned in an extended position prior to filling the weigh bin and/or determining the weight of GMUs in the weigh bin. In some embodiments, the telescoping segments are extended while the weight of GMUs is determined. In some embodiments, the telescoping segments are extended after the weight of GMUs is determined. At block 1108, the weigh bin gate is opened (e.g., via the controller) and the GMUs contained in the weigh bin are discharged via gravity through the weigh bin gate. In some embodiments the weigh bin gate is opened based on the telescoping segments being in a retracted or extended position. At block 1110, the telescoping chute receives the GMUs descending through the weigh bin gate. At block 1112, the telescoping chute guides the GMUs into the railcar. In some embodiments the telescoping chute is angled (e.g., based on an angle of repose of GMU) to slow the descent of GMUs. In some embodiments, the telescoping chute includes one or more baffle elements to further slow the descent of GMUs.

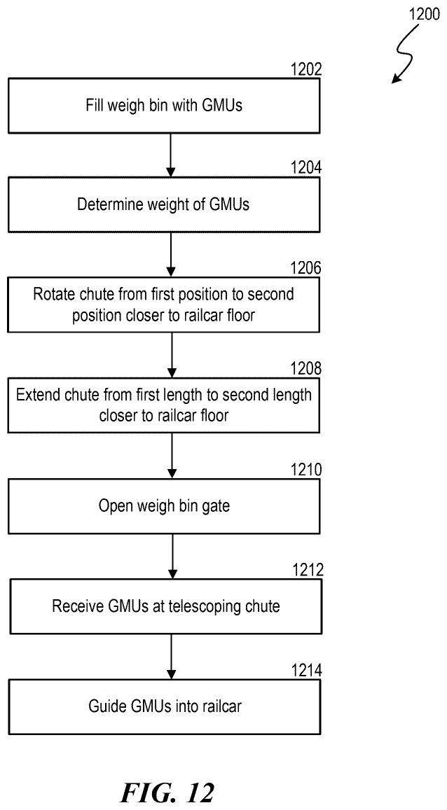

FIG. 12 is a flow diagram of a method 1200 of loading GMUs into railcars via an apparatus that articulates and telescopes in accordance with embodiments of the present technology. In some embodiments, parts of method 1200 are performed and/or carried out by any of the systems described throughout this document (e.g., systems 400, and 500 of FIGS. 4 and 5, respectively). In some embodiments, parts of method 1200 are performed and/or carried out using any of the articulating apparatuses with telescoping features described throughout this document (e.g., apparatus 900 of FIG. 9). In the present embodiments, one of the principal differences between method 1200 and methods 1000 and 1100 is that the method includes both articulating and telescoping chute features.

At block 1202, a weigh bin is filled with GMUs. At block 1204, a weight of the GMUs is determined. At block 1206, the chute is rotated from a first position to a second position such that an exit and/or end section of the chute is positioned closer to the floor of the railcar. In some embodiments, the first position places a longitudinal plane of the chute perpendicular to the direction of gravity. In some embodiments, the chute is pre-positioned (e.g., pre-rotated) in the second position prior to filling the weigh bin and/or determining the weight of GMUs in the weigh bin. In some embodiments the chute is rotated during determination of the weight of the GMUs in the weigh bin. In some embodiments the chute is rotated after the weight of the GMUs is determined.

At block 1208, telescoping segments of the chute extend such that the chute (e.g., the end section of the chute) is positioned closer to the railcar floor relative to being in a retracted position. In some embodiments, extending the telescoping segments includes extending each of a first telescoping segment and a second telescoping segment, where the second telescoping segment is distal to the first telescoping segment and closer to the floor of the railcar than the first telescoping segment. In some embodiments, the telescoping segments are pre-positioned in an extended position prior to filling the weigh bin and/or determining the weight of GMUs in the weigh bin. In some embodiments, the telescoping segments are extended while the weight of GMUs is determined. In some embodiments, the telescoping segments are extended after the weight of GMUs is determined. In some embodiments the telescoping segments are extended after rotation of the chute. In some embodiments, the telescoping segments are extended prior to rotation of the chute. In some embodiments, the telescoping segments are rotated during rotation of the chute.

At block 1210, the weigh bin gate is opened and the GMUs contained in the weigh bin are discharged via gravity through the weigh bin gate. In some embodiments, the weigh bin gate is opened based on the telescoping segments being in a retracted or extended position, and/or based on the chute being rotated in the first or second position. At block 1212, the chute receives the GMUs descending through the weigh bin gate. At block 1214, the chute guides the GMUs into the railcar. In some embodiments the chute is angled (e.g., based on an angle of repose of GMU) to slow the descent of GMUs. In some embodiments, the chute includes one or more baffle elements to further slow the descent of GMUs.

In some embodiments, a chute gate is positioned on the end section of the chute. The gate is configured to shift between a closed position, in which the gate covers an opening of the end section of the chute, and an open position in which the opening of the end section is uncovered. In some embodiments, the gate is pre-positioned in the closed position when the GMUs are received by the chute, such that the GMUs buildup in and are maintained within the chute and/or hopper. Once the GMUs from the weigh bin have built up in the chute and/or hopper, and the end section of the chute is positioned relatively close to the floor of the railcar, the gate is opened and the GMUs descend out of the chute and into the railcar. In some embodiments, the chute is then withdrawn (e.g., the telescoping segments are retracted) allowing the GMUs in the chute and/or hopper to further descend and form a pile in the railcar.

### IV. Conclusion

It will be apparent to those having skill in the art that changes may be made to the details of the above-described embodiments without departing from the underlying principles of the present technology. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. The term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing concentrations and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses or embodiments (1, 2, 3, etc.) for convenience. These are provided as examples and do not limit the present technology. It is noted that any of the dependent clauses can be combined in any combination, and placed into a respective independent clause.

1. A method of loading granulated metallic units (GMUs) into a railcar, the method comprising:
filling a weigh bin with GMUs;
determining a weight of the GMUs in the weigh bin;
opening a weigh bin gate positioned at an outlet section of the weigh bin;
receiving the GMUs at an articulating chute positioned below the weigh bin gate, wherein the articulating chute is angled and rotatable relative to the weigh bin about an axis; and
   guiding the GMUs through the articulating chute into the railcar.

2. The method of any of the claims herein, further comprising rotating the articulating chute from a first position to a second position, wherein an end section of the articulating chute is at a first height relative to a floor of the railcar when the articulating chute is in the first position and at a second height when the articulating chute is in the second position, wherein the second height is closer to the floor of the railcar than the first height.

3 The method of any of the claims herein, further comprising rotating the articulating chute from a first position to a second position, wherein an end section of the articulating chute is at a first height relative to a floor of the railcar when the articulating chute is in the first position and at a second height when the articulating chute is in the second position, wherein the second height is closer to the floor of the railcar than the first height, wherein a longitudinal plane of the articulating chute is perpendicular to the direction of gravity when the articulating chute is in the first position.

4. The method of any of the claims herein, wherein the second height is less than a height of one or more walls of the railcar.

5. The method of any of the claims herein, wherein the articulating chute further includes one or more baffle elements, and wherein the method further comprises slowing at least a portion of the GMUs guided through the articulating chute via the one or more baffle elements.

6. The method of any of the claims herein, wherein the articulating chute further includes a telescoping segment, and wherein the method further comprises extending the telescoping segment from a retracted configuration to an extended configuration, wherein:
the articulating chute is a first length when the telescoping segment is in the retracted configuration,
the articulating chute is a second length, greater than the first length, when the telescoping segment is in the extended configuration, and
the end section of the articulating chute is positioned closer to a floor of the railcar when the telescoping segment is in the extended configuration.

7. The method of any of the claims herein, wherein the telescoping segment is a first telescoping segment and the articulating chute further includes a second telescoping segment distal to the first telescoping segment, wherein the method further comprises extending the second telescoping segment distally from the first telescoping segment.

8. The method of any of the claims herein, further comprising:
transporting the GMUs via a conveyer mechanism;
receiving the GMUs by a surge bin via the conveyer mechanism, wherein the surge bin is positioned above the weigh bin;
supplying the GMUs to the weigh bin via the surge bin; and
shutting a surge bin gate when the GMUs supplied to the weigh bin is approximately a target weight of the GMUs.

9. The method of any of the claims herein, further comprising repositioning the railcar while the GMUs are being guided into the railcar through the articulating chute.

10. The method of any of the claims herein, further comprising establishing a target weight of the GMUs, wherein the target weight is based at least in part on a gross weight limit of a rail line and/or the railcar, and wherein opening the weigh bin gate is based at least in part on the GMUs at least meeting the target weight.

11. The method of any of the claims herein, wherein the gross weight limit of the rail line and/or railcar is at least 200,000 pounds.

12. An apparatus for loading granulated metallic units (GMUs) into a railcar, the apparatus comprising:
a housing unit defining a structure of the apparatus;
a weigh bin coupled to and within the housing, wherein the weigh bin includes a weigh bin gate positioned at an outlet of the weigh bin, wherein the weigh bin gate is moveable from a closed position in which the GMUs in the weigh bin are maintained in the weigh bin to an open position in which the GMUs are discharged via gravity past the weigh bin gate;
a hopper positioned below the weigh bin gate and configured to receive the GMUs discharged by the weigh bin gate, the hopper including an inlet having a first diameter and an outlet having a second diameter less than the first diameter, wherein the outlet is below the inlet; and
an articulating chute coupled to the hopper and positioned to receive the GMUs from the hopper, wherein:
   the articulating chute is angled and configured to guide the GMUs from a first height to a second height closer to a floor of the railcar than the first height, and
   the articulating chute is rotatable relative to the hopper about an axis.

14. The apparatus of any of the claims herein, wherein the articulating chute includes an outlet gate at an end portion of the articulating chute, the end portion being distal relative to the hopper.

15. The apparatus of any of the claims herein, wherein rotation of the articulating chute in a first direction about the axis positions the end portion from approximately the first height to approximately the second height, and rotation of the articulating chute in a second direction about the axis positions the end portion from approximately the second height to approximately the first height.

16. The apparatus of any of the claims herein, further comprising:
an inclined conveyer configured to transport GMUs, wherein the housing unit is configured to receive GMUs from the inclined conveyer.

17 The apparatus of any of the claims herein, wherein the inclined conveyer includes a plurality of chevron-shaped conveyer segments.

18. The apparatus of any of the claims herein, wherein the plurality of conveyer segments are comprised of one or more of: metal, metal alloy, metal cladding, and polyurethane.

19 The apparatus of any of the claims herein, further comprising one or more catch trays positioned below the inclined conveyer.

20. The apparatus of any of the claims herein, wherein the articulating chute includes one or more baffle elements positioned within an interior of the articulating chute, the baffle elements configured to partially restrict a flow of GMUs through the articulating chute.

21. The apparatus of any of the claims herein, wherein the articulating chute further includes one or more telescoping segments configured to extend from a first position to a second position and to retract from the second position to the first position, wherein an end portion of the articulating chute is positioned closer to the floor of the railcar when the telescoping segments are extended to the second position.

22. The apparatus of any of the claims herein, further comprising:
a surge bin coupled to and positioned within the housing, wherein the surge bin is positioned above the weigh bin, wherein the surge bin includes a surge bin gate positioned at an outlet of the surge bin, wherein the surge bin gate is moveable from a closed position in which GMUs are maintained in the surge bin to an open position in which the GMUs are discharged via gravity past the surge bin gate;
wherein the weigh bin is configured to receive GMUs from the surge bin.

23. A system configured to guide industrial product into a railcar, the system comprising:
a hopper including:
   an inlet configured to receive industrial product, the inlet having a first diameter; and
   an outlet having a second diameter less than the first diameter;
a rotatable chute positioned below the hopper and configured to receive industrial product from the hopper, wherein:
   the rotatable chute is angled based on an angle of repose of the industrial product, and wherein the rotatable chute is configured to guide industrial product from a first height to a second height, the second height being closer to a floor of the railcar than the first height,
   the rotatable chute is rotatable relative to the hopper about an axis, and
   the rotatable chute includes an end portion distal relative to the hopper; and
a controller operably coupled to the rotatable chute;
wherein the controller controls rotation of the rotatable chute, wherein rotation of the rotatable chute in a first direction about the axis positions the end portion from approximately the first height to approximately the second height, and rotation of the rotatable chute in a second direction about the axis positions the end portion from approximately the second height to approximately the first height.

24 The system of any of the claims herein, wherein the industrial product is GMU and the rotatable chute is angled based on an angle of repose of the GMU.

25. The system of any of the claims herein, wherein the angle of repose is at least 35 degrees.

26. An apparatus for loading GMUs into a railcar, the apparatus comprising:
a housing unit defining a structure of the apparatus;
a weigh bin coupled to and within the housing, wherein the weigh bin includes a weigh bin gate positioned at an outlet of the weigh bin, wherein the weigh bin gate is moveable from a closed position in which the GMUs in the weigh bin are maintained in the weigh bin to an open position in which the GMUs are discharged via gravity past the weigh bin gate;
a hopper positioned below the weigh bin gate and configured to receive the GMUs discharged by the weigh bin gate, the hopper including an inlet having a first diameter and an outlet having a second diameter less than the first diameter, wherein the outlet is below the inlet; and
a telescoping chute coupled to the hopper and positioned to receive the GMUs from the hopper, wherein:
   the telescoping chute includes one or more telescoping segments configured to extend from a first position to a second position and to retract from the second position to the first position, wherein an end portion of the telescoping chute is positioned closer to a floor of the railcar when the telescoping segments are extended to the second position, and
   the telescoping chute is angled based on an angle of repose of the GMUs, and wherein the telescoping chute is configured to guide GMUs from a first height to a second height, the second height being closer to a floor of the railcar than the first height.

I/We claim:

1. A method of loading granulated metallic units (GMUs) into a railcar, the method comprising:
filling a weigh bin with GMUs;
determining a weight of the GMUs in the weigh bin;
opening a weigh bin gate positioned at an outlet section of the weigh bin;
receiving the GMUs at an articulating chute positioned below the weigh bin gate, wherein the articulating chute is angled and rotatable relative to the weigh bin about an axis, wherein the axis is positioned above an end section of the articulating chute; and
guiding the GMUs through the articulating chute into the railcar.

2. The method of claim 1, further comprising rotating the articulating chute from a first position to a second position, wherein the end section is at a first height relative to a floor of the railcar when the articulating chute is in the first position and the end section is at a second height when the articulating chute is in the second position, and wherein the second height is closer to the floor of the railcar than the first height.

3. The method of claim 1, further comprising receiving the GMUs from the weigh bin at a hopper positioned above the articulating chute.

4. The method of claim 1, further comprising rotating the articulating chute relative to the weigh bin.

5. The method of claim 1, wherein the articulating chute further includes one or more baffle elements, extending inwardly from inner surfaces of the articulating chute and wherein the method further comprises slowing at least a portion of the GMUs guided through the articulating chute via the one or more baffle elements.

6. The method of claim 1, wherein the articulating chute further includes a telescoping segment, and wherein the method further comprises extending the telescoping segment from a retracted configuration to an extended configuration, wherein the end section of the articulating chute is positioned closer to a floor of the railcar when the telescoping segment is in the extended configuration.

7. The method of claim 6, wherein the telescoping segment is a first telescoping segment and the articulating chute further includes a second telescoping segment distal to the first telescoping segment, wherein the method further comprises extending the second telescoping segment distally from the first telescoping segment.

8. The method of claim 1, further comprising:
transporting the GMUs via a conveyer mechanism to a surge bin positioned above the weigh bin, wherein the conveyer mechanism is configured to reduce the loss of industrial product via one or more catch trays compared to conventional conveyer mechanisms;
supplying the GMUs to the weigh bin via the surge bin; and
shutting a surge bin gate of the surge bin based on a target weight of the weigh bin.

9. The method of claim 1, further comprising repositioning the railcar relative to the chute while guiding the GMUs into the railcar through the articulating chute.

10. The method of claim 1, further comprising determining a target weight of the GMUs based at least in part on a gross weight limit of a rail line and/or the railcar, and wherein opening the weigh bin gate is based at least in part on the GMUs at least meeting the target weight.

11. An apparatus for loading granulated metallic units (GMUs) into a railcar, the apparatus comprising:
a housing unit defining a structure of the apparatus;
a weigh bin coupled to and within the housing, wherein the weigh bin includes a weigh bin gate positioned at an outlet of the weigh bin, wherein the weigh bin gate is moveable from a closed position in which the GMUs in the weigh bin are maintained in the weigh bin to an open position in which the GMUs are discharged via gravity past the weigh bin gate;
a hopper positioned below the weigh bin gate and configured to receive the GMUs discharged by the weigh bin gate, the hopper including an inlet having a first diameter and an outlet having a second diameter less than the first diameter, wherein the outlet is below the inlet; and
an articulating chute coupled to the hopper and positioned to receive the GMUs from the hopper, wherein:
the articulating chute is angled and configured to guide the GMUs from a first height to a second height closer to a floor of the railcar than the first height.

12. The apparatus of claim 11, wherein the articulating chute is rotatable relative to the hopper about an axis.

13. The apparatus of claim 11, wherein the articulating chute is (i) rotatable relative to the hopper, and (ii) extendable from a retractable position to an extended position.

14. The apparatus of claim 11, wherein rotation of the articulating chute in a first direction about an axis positions an end portion from approximately the first height to approximately the second height, and rotation of the articulating chute in a second direction about the axis positions the end portion from approximately the second height to approximately the first height.

15. The apparatus of claim 11, wherein the articulating chute includes one or more baffle elements positioned within an interior of the articulating chute, wherein the baffle elements are configured to partially restrict a flow of GMUs through the articulating chute.

16. The apparatus of claim 11, wherein the articulating chute has a first outer surface portion and a second outer surface portion distal to the first outer surface portion, wherein the second outer surface portion is angled relative to the first outer surface portion.

17. The apparatus of claim 11, further comprising a surge bin coupled to and positioned within the housing, wherein the surge bin is positioned above the weigh bin and includes a surge bin gate positioned at an outlet of the surge bin, wherein the surge bin gate is moveable from a closed position in which GMUs are maintained in the surge bin to an open position in which the GMUs are discharged via gravity past the surge bin gate, wherein the weigh bin is configured to receive GMUs from the surge bin.

18. An apparatus for loading GMUs into a railcar, the apparatus comprising:
a housing unit defining a structure of the apparatus;
a weigh bin coupled to and within the housing, wherein the weigh bin includes a weigh bin gate positioned at an outlet of the weigh bin, wherein the weigh bin gate is moveable from a closed position in which the GMUs in the weigh bin are maintained in the weigh bin to an open position in which the GMUs are discharged via gravity past the weigh bin gate; and
a telescoping chute positioned to receive the GMUs from the weigh bin, wherein:
the telescoping chute includes one or more telescoping segments configured to extend from a first position to a second position and to retract from the second position to the first position, wherein an end portion of the telescoping chute is positioned closer to a floor of the railcar when the telescoping segments are extended to the second position, and
the telescoping chute is angled based on an angle of repose of the GMUs, and wherein the telescoping chute is configured to guide GMUs from a first height to a second height, the second height being closer to a floor of the railcar than the first height.

19. The apparatus of claim 18, further comprising a hopper positioned below the weigh bin gate and configured to receive the GMUs discharged by the weigh bin gate.

20. The apparatus of claim 19, wherein the hopper includes an inlet having a first cross-sectional dimension and an outlet having a second cross-sectional dimension less than the first cross-sectional dimension.
